(19) United States
(12) Patent Application Publication
(10) Pub. No.: US 2004/0078496 A1
(43) Pub. Date: Apr. 22, 2004

(54) Information file data structure, information file generating method, information file generating apparatus, information file reproducing method, information file reproducing apparatus, and storage medium

(76) Inventors: Takayuki Kunieda, Toyko (JP); Yuki Wakita, Tokyo (JP); Takao Saka, Kanagawa (JP)

Correspondence Address: DICKSTEIN SHAPIRO MORIN & OSHINSKY LLP, 2101 L STREET NW, WASHINGTON, DC, 20037-1526, US

(21) Appl. No.: 10/634,816

(22) Filed: Aug. 6, 2003

(30) Foreign Application Priority Data
Aug. 9, 2002 (JP) 2002-233776
Apr. 14, 2003 (JP) 2003-109542

(51) Int. Cl. G06F 3/00

(52) U.S. Cl. 710/1

(57) ABSTRACT

An information file data structure is formed by time-varying audio-visual main information, and meta information annexed to the main information. The meta information includes meta display information which is displayable, and event information for synchronizing display of the meta display information to the main information.

### BACKGROUND OF THE INVENTION

This application claims the benefit of Japanese Patent Applications No.2002-233776 filed Aug. 9, 2003 and No.2003-109542 filed Apr. 14, 2003, in the Japanese Patent Office, the disclosure of which is hereby incorporated by reference.

1. Field of the Invention

The present invention generally relates to, and more particularly to information file data structures, information file generating methods, information file generating apparatuses, information file reproducing methods, information file reproducing apparatuses and storage media, and more particularly to an information file data structure for an information file having audio-visual main information such as video, image and/or audio information, and meta information added to the main information. The present invention also relates to an information file generating method and an information file generating apparatus for generating such an information file, an information file reproducing method and an information file reproducing apparatus for reproducing such an information file, and a computer-readable storage medium which stores a computer program for causing a computer to generate or reproduce such an information file.

2. Description of the Related Art

Conventionally, in movies, television broadcast and the like, meta information for caption, sub-channel audio and the like is added to the audio-visual information (main information) such as video, image and/or audio information. In the case of a movie program on an existing ground wave television broadcast, for example, the caption is embedded to the main information, that is, the video information of the movie program, as the meta information in the case of a foreign-language movie. Alternatively, the audio information before the dubbing is broadcast as the meta information on one of the stereo channels.

Recently, due to drastic developments in information technology and information communication technology, the audio-visual information such as the video, image and/or audio information is easily accessible by a user. The audio-visual information may be distributed over the Internet, or distributed in the form of recording media such as optical disks which store the audio-visual information. Generally, the audio-visual information is treated in the form of electronic data. The audio-visual information in the form of the electronic data is formed by the main information and the meta information in many cases as described above, and in general, the audio-visual information has a data structure such that the meta information is embedded in the main information.

For example, in a case where character information which forms the meta information is embedded within the video information which forms the main information, the embedded character information does not take the form of character code information but is embedded within the video information in the form of image, that is, bit-map pattern. For this reason, it is virtually impossible to reuse the embedded character information, and it is impossible to change a display position of the embedded character information. In other words, it is virtually impossible to independently utilize the meta information.

On the other hand, techniques are being developed to treat the main information and the meta information as separate information. For example, in the case of MPEG-7, contents of the video and/or audio information are represented as meta information, but since various kinds of information can be treated as objects, it is possible to treat the information and the meta information thereof as separate information.

Another technique, such as Synchronized Multimedia Integration Language (SMIL), has also been proposed. The SMIL synchronizes the independent main information, such as the video and/or audio information, with the meta information thereof, so as to generate a single data structure for the main and meta information.

Other techniques for synchronizing the independent main information, such as the video and/or audio information, with the meta information thereof, have been proposed in Japanese Laid-Open Patent Applications No.10-55391 and No.2002-232858, for example. According to these proposed techniques, if the meta information is a certain material, for example, time information is recorded at a timing when a unit (for example, a page) of the certain material forming the meta information changes, and this time information is referred to at the time of a reproduction to synchronize and reproduce the main information, such as the video and/or audio information, and the certain material forming the meta information.

However, in the case of the MPEG-7, for example, if the main information is video information, the meta information must be generated for every frame which forms the video information, in order to generate the meta information which is added to the video information. As a result, there was a problem in that it requires an extremely troublesome operation to generate and reproduce an information file of the main information and the meta information.

### SUMMARY OF THE INVENTION

Accordingly, it is a general object of the present invention to provide a novel and useful information file data structure, information file generating method, information file generating apparatus, information file reproducing method, information file reproducing apparatus and computer-readable storage medium, in which the problems described above are eliminated.

Another and more specific object of the present invention is to provide an information file data structure, information file generating method, information file generating apparatus, information file reproducing method, information file reproducing apparatus and computer-readable storage medium, which enable easy generation of an information file by treating the main information and the meta information thereof as separate information.

Still another and more specific object of the present invention is to provide an information file data structure comprising time-varying audio-visual main information; and meta information, annexed to the main information, including meta display information which is displayable and event information for synchronizing display of the meta display information to the main information. According to the information file data structure of the present invention, the data structure of the main information does not depend on the data structure of the meta display information. For example, if the main information is video information, 30 frames may exist per second, but it is unnecessary to generate the meta display information for each frame. For this reason, the meta display information can be generated independently of the main information, thereby making the generation of the meta display information easy. In addition, it is possible to reproduce the main information and the meta display information, which are independent, in synchronism with each other. Since the main information and the meta display information are independent, it is possible to freely display the meta display information in various display formats.

A further object of the present invention is to provide an information file generating method comprising the steps of (a) generating time-varying audio-visual main information; and (b) generating meta information, annexed to the main information, including meta display information which is displayable and event information for synchronizing display of the meta display information to the main information. According to the information file generating method of the present invention, the data structure of the main information does not depend on the data structure of the meta display information. For example, if the main information is video information, 30 frames may exist per second, but it is unnecessary to generate the meta display information for each frame. For this reason, the meta display information can be generated independently of the main information, thereby making the generation of the meta display information easy. In addition, it is possible to reproduce the main information and the meta display information, which are independent, in synchronism with each other. Since the main information and the meta display information are independent, it is possible to freely display the meta display information in various display formats.

Another object of the present invention is to provide an information file generating apparatus comprising a first generating section to generate time-varying audio-visual main information; and a second generating section to generate meta information, annexed to the main information, including meta display information which is displayable and event information for synchronizing display of the meta display information to the main information. According to the information file generating apparatus of the present invention, the data structure of the main information does not depend on the data structure of the meta display information. For example, if the main information is video information, 30 frames may exist per second, but it is unnecessary to generate the meta display information for each frame. For this reason, the meta display information can be generated independently of the main information, thereby making the generation of the meta display information easy. In addition, it is possible to reproduce the main information and the meta display information, which are independent, in synchronism with each other. Since the main information and the meta display information are independent, it is possible to freely display the meta display information in various display formats.

Still another object of the present invention is to provide a computer-readable storage medium which stores a computer program for causing a computer to generate an information file, the computer program comprising a first procedure to cause the computer to generate time-varying audio-visual main information; and a second procedure to cause the computer to generate meta information, annexed to the main information, including meta display information which is displayable and event information for synchronizing display of the meta display information to the main information. According to the computer-readable storage medium of the present invention, the data structure of the main information does not depend on the data structure of the meta display information. For example, if the main information is video information, 30 frames may exist per second, but it is unnecessary to generate the meta display information for each frame. For this reason, the meta display information can be generated independently of the main information, thereby making the generation of the meta display information easy. In addition, it is possible to reproduce the main information and the meta display information, which are independent, in synchronism with each other. Since the main information and the meta display information are independent, it is possible to freely display the meta display information in various display formats.

A further object of the present invention is to provide an information file reproducing method comprising the steps of (a) analyzing an information file comprising time-varying audio-visual main information and meta information, the meta information being annexed to the main information and including meta display information which is displayable and event information for synchronizing display of the meta display information to the main information; and (b) reproducing the main information and the meta display information of the information file which is analyzed by synchronizing the main information and the meta display information by the event information. According to the information file reproducing method of the present invention, the data structure of the main information does not depend on the data structure of the meta display information. For example, if the main information is video information, 30 frames may exist per second, but it is unnecessary to generate the meta display information for each frame. For this reason, the meta display information can be generated independently of the main information, thereby making the generation of the meta display information easy. In addition, it is possible to reproduce the main information and the meta display information, which are independent, in synchronism with each other. Since the main information and the meta display information are independent, it is possible to freely display the meta display information in various display formats.

Another object of the present invention is to provide an information file reproducing apparatus comprising an analyzing section to analyze an information file comprising time-varying audio-visual main information and meta information, the meta information being annexed to the main information and including meta display information which is displayable and event information for synchronizing display of the meta display information to the main information; and a reproducing section to reproduce the main information and the meta display information of the information file which is analyzed by synchronizing the main information and the meta display information by the event information. According to the information file reproducing apparatus of the present invention, the data structure of the main information does not depend on the data structure of the meta display information. For example, if the main information is video information, 30 frames may exist per second, but it is unnecessary to generate the meta display information for each frame. For this reason, the meta display information can be generated independently of the main information, thereby making the generation of the meta display information easy. In addition, it is possible to reproduce the main information and the meta display information, which are independent, in synchronism with each other. Since the main information and the meta display information are independent, it is possible to freely display the meta display information in various display formats.

Still another object of the present invention is to provide a computer-readable storage medium which stores a computer program for causing a computer to reproduce an information file, the computer program comprising a first procedure causing the computer to analyze an information file comprising time-varying audio-visual main information and meta information, the meta information being annexed to the main information and including meta display information which is displayable and event information for synchronizing display of the meta display information to the main information; and a second procedure causing the computer to reproduce the main information and the meta display information of the information file which is analyzed by synchronizing the main information and the meta display information by the event information. According to the computer-readable storage medium of the present invention, the data structure of the main information does not depend on the data structure of the meta display information. For example, if the main information is video information, 30 frames may exist per second, but it is unnecessary to generate the meta display information for each frame. For this reason, the meta display information can be generated independently of the main information, thereby making the generation of the meta display information easy. In addition, it is possible to reproduce the main information and the meta display information, which are independent, in synchronism with each other. Since the main information and the meta display information are independent, it is possible to freely display the meta display information in various display formats.

Other objects and further features of the present invention will be apparent from the following detailed description when read in conjunction with the accompanying drawings.

### BRIEF DESCRIPTION OF THE DRAWINGS

FIG. 1 is a diagram showing a general hardware structure of an entire information file generation system to which an embodiment of the present invention is applied;

FIG. 2 is a system block diagram showing an important part of a personal computer used by the information file generation system;

FIG. 3 is a functional block diagram of the information file generation system;

FIGS. 4A, 4B and 4C are diagrams for explaining a meta information generating process;

FIG. 5 is a diagram for explaining a first technique for synchronizing main information and meta information;

FIG. 6 is a diagram for explaining a second technique for synchronizing the main information and the meta information;

FIG. 7 is a diagram for explaining a third technique for synchronizing the main information and the meta information;

FIG. 8 is a diagram for explaining a capturing process and a file structure of an information file generated thereby;

FIG. 9 is a diagram for explaining a manual information file generating process;

FIG. 10 is a diagram showing meta information written in MPEG-7;

FIG. 11 is a diagram showing the file structure of the information file in more detail;

FIG. 12 is a functional block diagram for explaining an information file reproducing process;

FIGS. 13A and 13B are diagrams for explaining integrated displays of information in an SMIL template based on the meta information;

FIGS. 14A and 14B are diagrams for explaining arbitrary displays of meta display information; and

FIG. 15 is a diagram for explaining a display of an information file.

### DESCRIPTION OF THE PREFERRED EMBODIMENTS

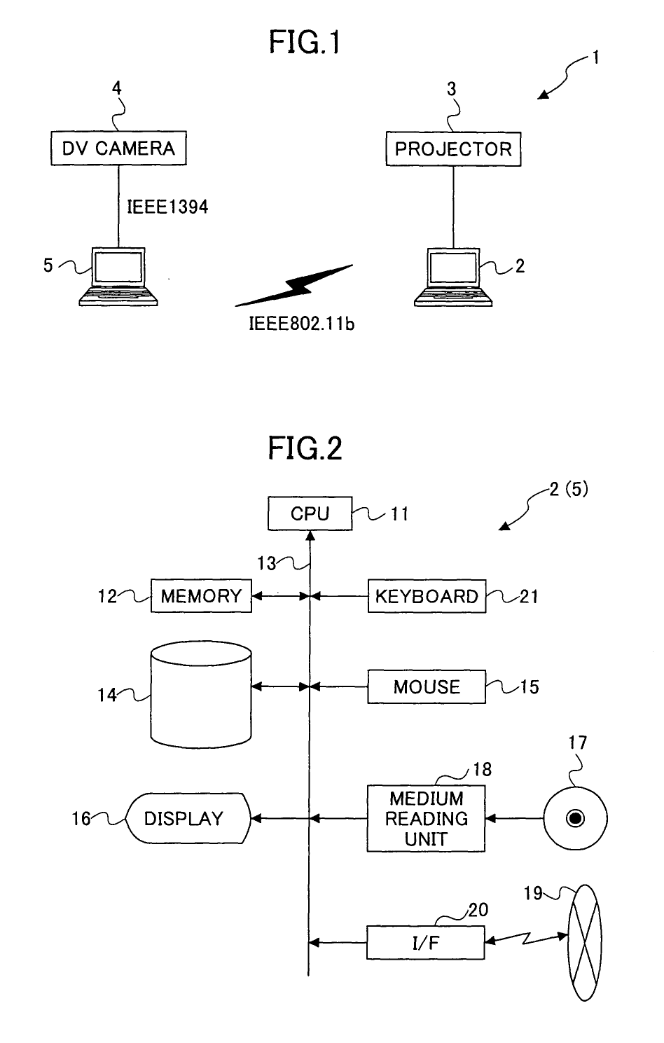

FIG. 1 is a diagram showing a general hardware structure of an entire information file generation system to which an embodiment of the present invention is applied. An information file generation system 1 shown in FIG. 1 employs an embodiment of an information file generating method according to the present invention, an embodiment of an information file generating apparatus according to the present invention, an embodiment of an information file reproducing method according to the present invention, an embodiment of an information file reproducing apparatus according to the present invention, and an embodiment of a computer-readable storage medium according to the present invention.

In this embodiment, it is assumed for the sake of convenience that a video recording is to be made of a lecture or presentation using an electronic presentation material. When making such a lecture or presentation, a lecturer or presenter normally stores the electronic presentation material in a personal computer (PC) which is connected to a projector, and makes the lecture or presentation while operating a presentation software to display the presentation material by the projector.

The information file generation system 1 includes a presentation PC 2, a projector 3 which is connected to the presentation PC 2 and displays the presentation video, a digital video (DV) camera 4 having a function of taking a motion picture of the presentation as well as picking up audio, and an imaging PC 5 which is connected to the DV camera 4 via an interface such as an IEEE1394 in a manner capable controlling the DV camera 4. The presentation PC 2 and the imaging PC 5 are connected via a communication interface such as an IEEE802.11b. When no wireless communication environment is available, a peer-to-peer connection using a normal Ethernet may be used to connect the presentation PC 2 and the imaging PC 5.

FIG. 2 is a system block diagram showing an important part of the PCs 2 and 5 used by the information file generation system 1 shown in FIG. 1. Each of the PCs 2 and 5 has a CPU 11 and a memory 12 which are connected via a bus 13. The CPU 11 carries out various operations and centrally controls each part of the PC 2 or 5. For example, the memory 13 includes a ROM which may store one or more computer programs to be executed by the CPU 11 and various data to be used by the CPU 11, and a RAM which may store various data including intermediate data obtained during operations carried out by the CPU 11.

A storage unit 14 having one or more magnetic hard disks, a mouse 15, a keyboard 21, and a display unit 16 are connected to the bus 13 via suitable interfaces. The mouse 15 and the keyboard 21 are provided as input devices, and the display unit 16 is provided as an output device. The display unit 16 is formed by a liquid crystal display (LCD) or the like. A medium reading unit 18 which reads a storage medium 17 such as an optical disk, may be connected to the bus 13. In addition, a communication interface (I/F) 20 which communicates with a network 19 such as the Internet, may be connected to the bus 13. The storage medium 17 may be selected from various types including flexible disks, magneto-optic disks, and optical disks such as compact disks (CDs) and digital versatile disks (DVDs). An optical disk unit, a magneto-optic disk unit or the like is used for the medium reading unit 18 depending on the type of the recording medium 17 used.

An information file generating program is stored in the storage unit 14 of each of the PCs 2 and 5. This information file generating program may be read from the storage medium 17 by the medium reading unit 18 or, downloaded from the network 19 such as the Internet via the communication interface 20, and installed in the storage unit 14. The hard disk of the storage unit 14 or the storage medium 17 read by the medium reading unit 18 forms the computer-readable storage medium which stores the information file generating program.

By installing the information file generating program in the storage unit 14, each of the PCs 2 and 5 assumes a state capable of generating an information file. In other words, the CPU 11 can carry out operations based on the information file generating program, so as to realize functions (various means and steps of the present invention) of various modules which will be described later. The information file generating program may form a portion of a particular application software. The information file generating program may also operate on a predetermined operating system (OS) or, operate by use of a portion of the operating system. The storage unit 14 of the presentation PC 2 also stores a predetermined presentation software.

Next, a description will be given of the contents of the processes carried out by the information file generation system 1 based on the information file generating program.

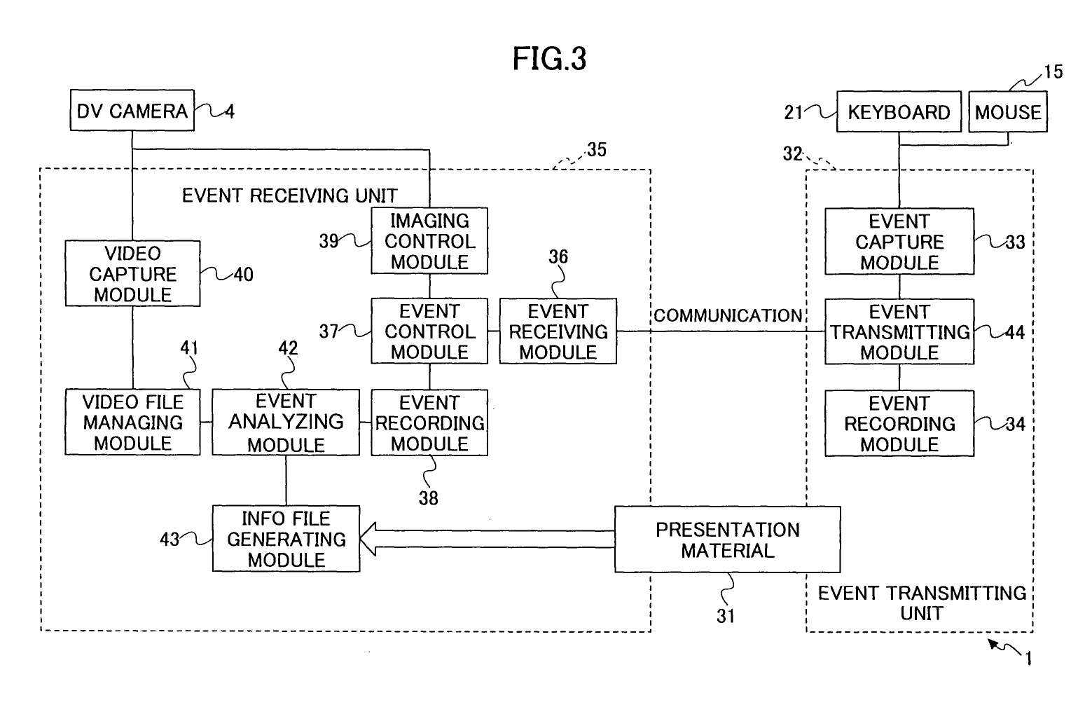

FIG. 3 is a functional block diagram of the information file generation system 1 realized by the information file generating program and the like.

The presentation PC 2 stores an electronic presentation material 31 in the storage unit 14. The lecturer or presenter (hereinafter simply referred to as a user) makes a presentation using the presentation material 31 by the presentation software.

Normally, the operation of the presentation PC 2 includes the following procedures ST1 through ST7 when making the presentation.

ST1: Turn ON the presentation PC 2.

ST2: Start the presentation software.

ST3: Start the presentation.

ST4: Turn the page by operating the keyboard 21 or the mouse 15.

ST5: End the presentation.

ST6: End the presentation software.

ST7: Turn OFF the presentation PC 2.

The presentation PC 2 also functions as an event capture module 33 and an event recording module 34 of an event transmitting unit 32 based on the information file generating program, and supports efficient generation of meta information with respect to audio-visual information which is picked up (that is, captured) by the DV camera 4 and input to the presentation PC 2, by carrying out the operation of the presentation PC 2 as the event transmitting unit 32, that is, appropriately recording the event which is generated with respect to the audio-visual information (contents) to be picked up and input to the presentation PC 2 when the presentation is made. The meta information describes the main information such as the audio-visual information.

When the presentation is made by the procedures described above, the following events E1 through E3, for example, may be generated with respect to the audio-visual information (contents) which can be captured in the presentation PC 2. In other words, an operation of the presentation PC 2 which switches the picture of the presentation video forming at least a portion of the picked up image within the audio-visual information which is picked up by the DV camera 4 is regarded as an event. Further, it is necessary to accurately record a kind and a generation time of the event as event information related to the generated event.

E1: Start and end of the presentation software.

E2: Operation of the keyboard 21 (which key is pushed).

E3: Operation of the mouse 15 (drag or click).

The event transmitting unit 32 capture the kind and the generation time of the event as the event information, by the event capture module 33. The event recording module 34 records a log (event information) of the event information, and an event transmitting module 44 transmits the event information (log) to the imaging PC 5 via the communication interface 20. More particularly, the event transmitting module 44 transmits the event information and the log to an event receiving unit 35 which is realized by the imaging PC 5 based on the information file generating program.

The event information transmitted from the event transmitting unit 32 is received by an event receiving module 36 of the event receiving unit 35. An event control module 37 supplies the received event information to an event recording module 38 and an imaging control module 39. The event recording module 38 records the event information time-sequentially.

The imaging control module 39 controls the DV camera 4 based on the event information. A video capture module 40 captures the audio-visual information which is picked up and input by the DV camera 4. A video file managing module 41 stores and manages an audio-visual file of the audio-visual information which is picked up and input by the DV camera 4. The event information recorded by the event recording module 38 not only includes the event information received from the event transmitting unit 32, but also includes event information related to the control of the DV camera 4.

An event analyzing module 42 analyzes the contents of the event information. An information file generating module 43 refers to the contents of the event information analyzed by the event analyzing module 42, and generates an information file based on the audio-visual file and the presentation material 31 stored in the storage unit 14 of the imaging PC 5.

Next, a description will be given of the sending of event information between the event transmitting unit 32 to the event receiving unit 35. In this case, synchronizing information for integrating the event information is exchanged between the event transmitting unit 32 and the event receiving unit 35.

First, when an event is generated by the start of the presentation software, the imaging control module 39 starts to pickup the audio-visual information by the DV camera 4. In addition, event information related to this event is recorded by the event recording module 38.

Second, when the turning of the page of a slide show of the presentation material 31 progresses, an event is generated by the key operation of the keyboard 21, and event information related to this event is recorded by the event recording module 38.

Third, when an event is generated by the end of the presentation software, the picking up of the audio-visual information by the DV camera 4 is ended by the imaging control module 39. In addition, event information related to this event is recorded by the event recording module 38.

Accordingly, the event information of the event within the audio-visual information picked up by the DV camera 4 can be managed by the event receiving unit 35 together with the audio-visual information. In other words, the audio-visual information picked up by the DV camera 4 is stored, as the main information, by being added with first time information which prescribes a transition in time. In addition, the recorded event information is integrated with the presentation material 31 by the information file generating module 43, and is managed by a content description language such as MPEG-7. The above described processes can be realized by the following procedures ST11 through ST13.

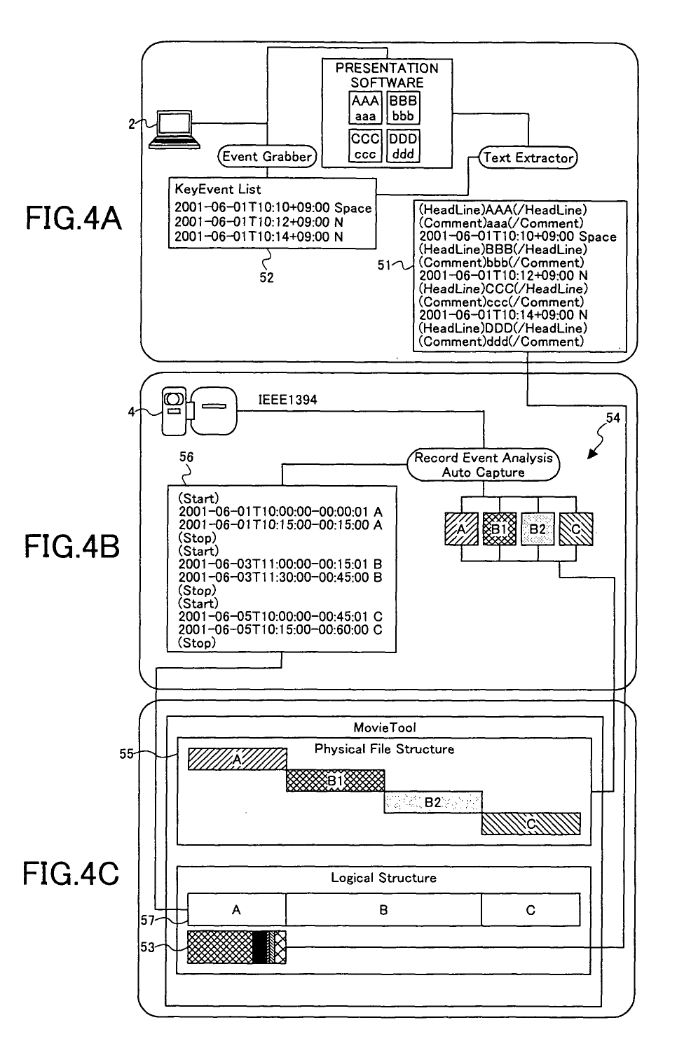

FIGS. 4A, 4B and 4C are diagrams for explaining a meta information generating process.

ST11: The presentation contents annexed to the event information may be added by this procedure in the following manner. For example, if the key operation on the keyboard 21 is “N, N, N, P, N, N” in this order and events are generated thereby, a page transition of the presentation material 31 can be predicted as being “1, 2, 3, 2, 3, 4”. Hence, as shown in FIG. 4A, meta display information 51 formed by character information is extracted from a page of the presentation material 31 corresponding to the generated event, and is added to event information 52 caused by the operation of the keyboard 21. As a result, it is possible to generate meta information 53 having the event information 52 accompanying a character string (meta display information 51) representing the presentation contents displayed at the event generation time, as shown in FIG. 4C.

ST12: An audio-visual physical file structure with respect to the audio-visual information is formed by this procedure in the following manner. That is, the audio-visual information which is actually picked up and input by the DV camera 4 is stored in units of imaged cuts as audio-visual physical files (A, B1, B2 and C) 54 (AVI, MPEG-1, 2, 4 or the like), as shown in FIG. 4B. A collection (or group) of audio-visual information actually having a significant meaning is treated as main information 55 which is formed by an audio-visual file group including the audio-visual files (A, B1, B2 and C) 54, as shown in FIG. 4C.

ST13: Mapping of the event information including the presentation contents and the audio-visual physical file is carried out by this procedure in the following manner. The main information 55 which is formed by the audio-visual file group managed as a group having a significant meaning, and the meta information 53, are made to correspond to each other by a time code recorded in the audio-visual information as shown in FIG. 4C, so that it is possible to specify a time relationship of the event and the video reproducing position. If no time code is recorded in the audio-visual information, the audio-visual information is converted into a number of frames per second to obtain time information which is to be used in place of the time code. Hence, it is possible to record the main information 55 which is the audio-visual information and the event information 52 in time-sequential correspondence with each other. Event information 56 related to the start and end of the pickup operation of the DV camera 4 is also made to correspond to the audio-visual information (main information 55) as meta information 57.

Therefore, the main information 55 formed by the audio-visual file group and the meta information 53 and 57 for managing content information of the main information 55 are recorded in a synchronized state, so that it is easy to manage the main information 55 and the meta information 53 and 57.

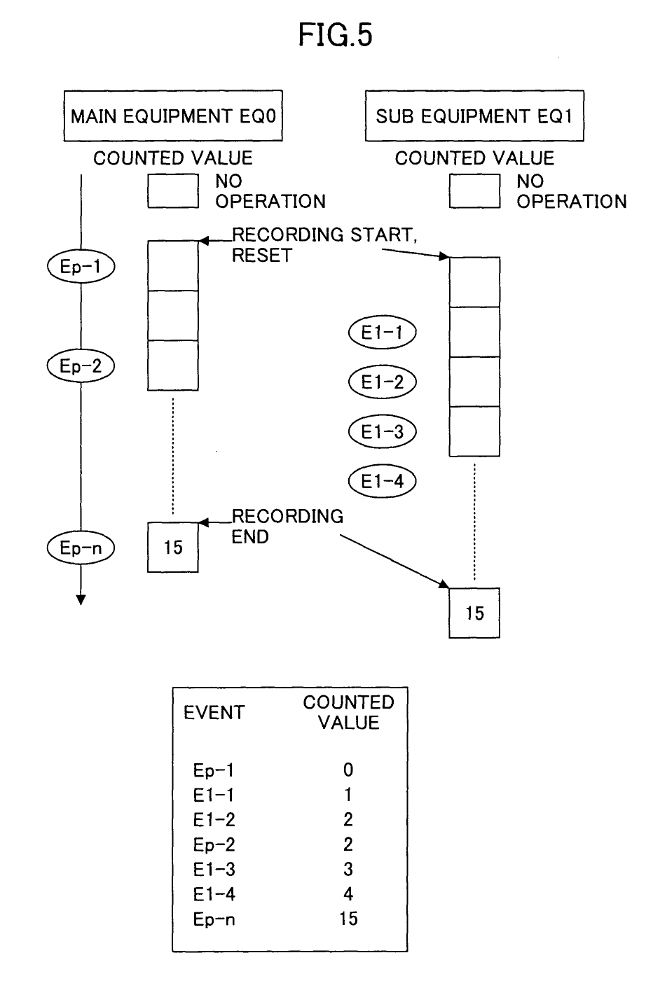

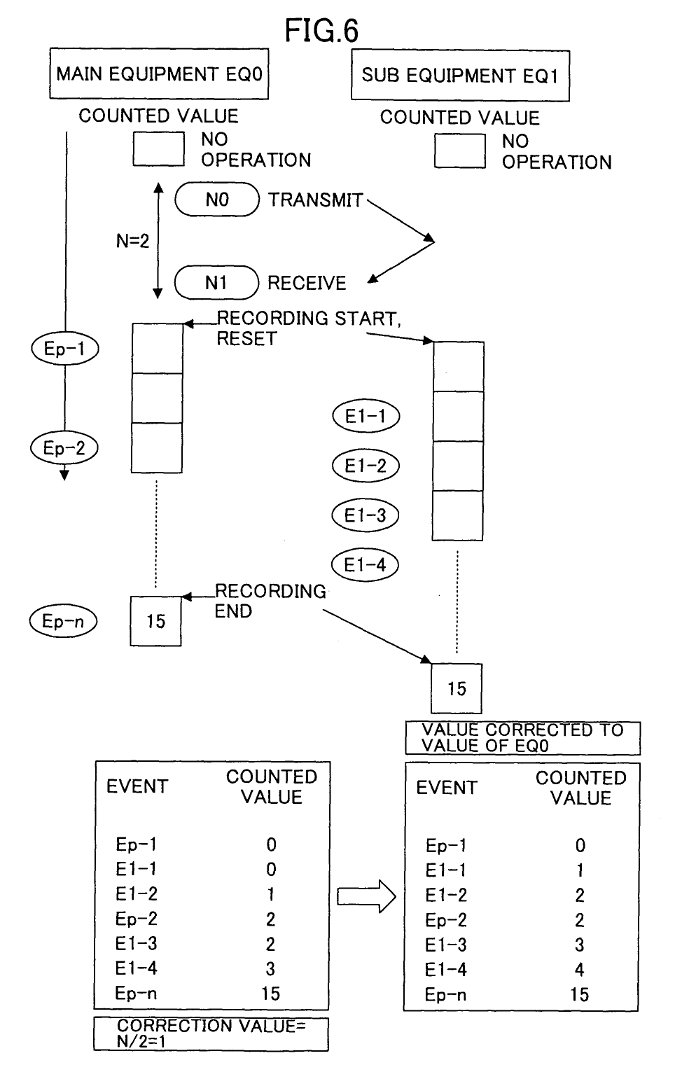

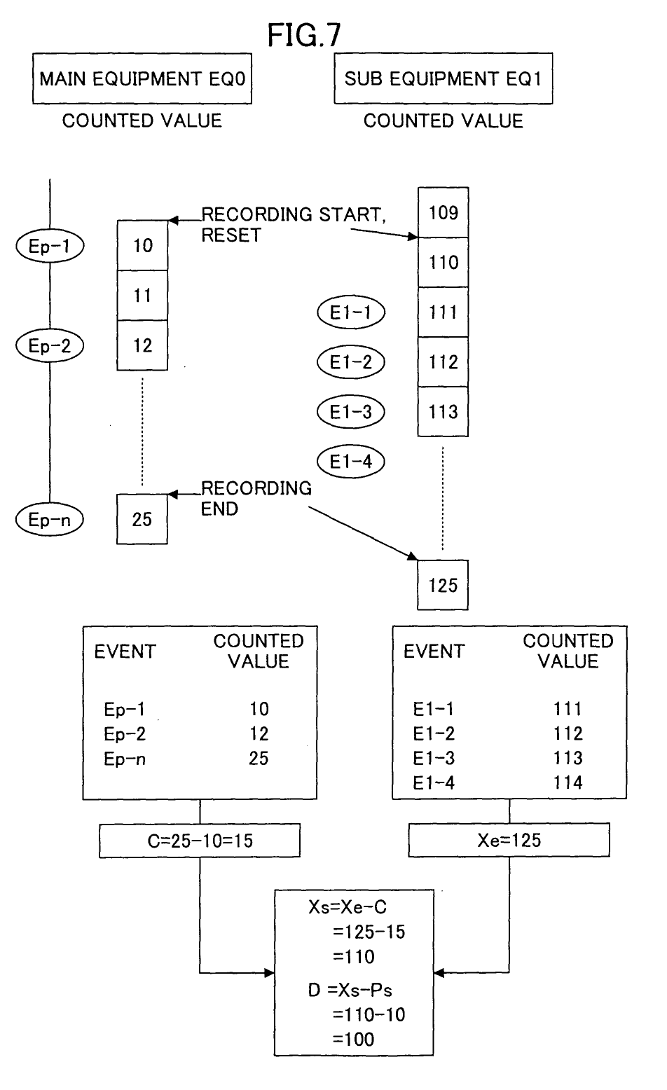

Next, a description will be given of techniques for synchronizing the main information 55 formed by the audio-visual file group and the meta information 53 and 57 which manage content information of the main information 55, by referring to FIGS. 5 through 7. FIG. 5 is a diagram for explaining a first technique for synchronizing the main information and the meta information 53 and 57. FIG. 6 is a diagram for explaining a second technique for synchronizing the main information 55 and the meta information 53 and 57. In addition, FIG. 7 is a diagram for explaining a third technique for synchronizing the main information 55 and the meta information 53 and 57.

First, a description will be given of the first technique for synchronizing the main information 55 and the meta information 53 and 57, by referring to FIG. 5. First, it is assumed for the sake of convenience that the presentation PC 2 and the imaging PC 5 are formed by a single computer. In this case, the CPU 11 and the memory 12 within the single computer forming the PCs 2 and 5 are utilized to realize a counter which successively increments a counted value by a predetermined count-up unit (value). This counter is reset simultaneously as the start of the presentation, and for example, is reset to a specific value (normally 0) when the presentation software is started. The increase of the counted value of the counter after being reset is indicated by rectangular frames in FIG. 5. Every time an event is generated, the contents of the event and the counted value of the counter at that time are recorded as a synchronizing signal forming the event information. In FIG. 5, the event is indicated by oval frames in correspondence with the rectangular frames indicating the counted value. The above described process is continued until the presentation ends. The count-up unit of the counter may be an arbitrary value, such as a time unit of N (for example, 1) frames of the main information 55 or N (for example, 1) seconds, and a clock frequency of the CPU 11 such as N (for example, 1) clocks. The synchronizing signal which forms the event information and is recorded, is finally recorded in the information file by the by the information file generating module 43. Accordingly, the main information 55 formed by the audio-visual file group and the meta information 53 and 57 managing the content information thereof are recorded in a synchronizable state so that they can be managed.

Although it was assumed for the sake of convenience that the single computer forms the PCs 2 and 5, a description will be given of an example of the event by regarding the PCs 2 and 5 as two separate computers. In the presentation PC 2 which carries out the presentation, the event may be a change in units of the presentation material 31, such as switching of the page, switching of the file, switching of the URL and switching of a demonstration which executes an arbitrary application in the PC 2. For example, when providing a guidance on the functions and on how to use the software, the switching of the demonstration may change the guidance in units of guidance screens (or displays) or, in units of time required for a process to end from a time when a button selecting this process is manipulated. In the imaging PC 5, the event may be subjective audio information such as “this portion is important” and “this portion needs attention” input from the DV camera 4, and an input operation such as “demonstration” not detected by the presentation PC 2. Of course, the events of the PCs 2 and 5 are not limited to the above.

Thereafter, when reproducing the information file, the counter is operated in response to the start of reproducing the main information 55, with the same units as those used at the time of the recording. The synchronizing signal forming the event information is read, and the presentation material 31 or the like at the time when the event is generated is displayed. Alternatively, the counted value of the synchronizing signal forming the event information is converted into a time value using 00 h:00 m:00 s:00 f as a starting point, where h denotes hour, m denotes minute, s denotes second, and f denotes millisecond (or fraction of the second), and the presentation material 31 or the like at the time when the event is generated is displayed together with the reproduction of the main information 55 according to the time corresponding to the counted value.

Next, a description will be given of the case where the PCs 2 and 5 are separate and independent computers. As described above, the PCs 2 and 5 can communicate with each other. For the sake of convenience, the imaging PC 5 is determined as being a main equipment EQ0 and the presentation PC 2 is determined as being a sub equipment EQ1, for example. The counter is operated in the main equipment EQ0, and a counter reset operation is first carried out. The main equipment EQ0 sends to the sub equipment EQ1 an instruction to reset and operate the counter of the sub equipment EQ1 in response to the resetting of the counter of the main equipment EQ0. Hence, the counter of the sub equipment EQ1 is also reset. As a result, the main and sub equipments EQ0 and EQ1 carry out adding operations of the respective counters approximately at the same timing. Then, the synchronizing signal forming the event information is recorded by the event recording modules 34 and 38 in each of the main and sub equipments EQ0 and EQ1 by the technique described above. When the presentation ends, the main equipment EQ0 sends an instruction to end the recording to the sub equipment EQ1, and the recorded information is sent from the main equipment EQ0 to the sub equipment EQ1 according to this instruction. The synchronizing signal forming the event information, which is generated in the main and sub equipments EQ0 and EQ1 and is to be recorded, is finally recorded in the information file by the information file generating module 43. Thus, the main information 55 formed by the audio-visual file group and the meta information 53 and 57 managing the content information thereof are recorded in a synchronizable state so that they can be managed.

It is assumed for the sake of convenience that there is only one presentation PC 2, that is, only one sub equipment EQ1. However, the recording of the event information by the technique described above is of course possible when a plurality of presentation PCs 2, that is, a plurality of sub equipments EQ1, are provided.

Next, a description will be given of the second technique for synchronizing the main information 55 and the meta information 53 and 57, by referring to FIG. 6. In FIG. 6, those parts which are the same as those corresponding parts in FIG. 5 are designated by the same reference numerals, and a description thereof will be omitted. According to the first technique described above with reference to FIG. 5, an error amounting to a time it takes for a communication between the main and sub equipments EQ0 and EQ1 is introduced in the event information which is generated in the main and sub equipments EQ0 and EQ1. But if such an error is negligible, the first technique described above with reference to FIG. 5 introduces no inconveniences.

On the other hand, if the error amounting to the time it takes for the communication between the main and sub equipments EQ0 and EQ1 is not negligible, it is necessary to carry out an error correction process as in the case of the second technique shown in FIG. 6. In other words, in the process of sending the data from the main equipment EQ0 to the sub equipment EQ1 and returning the data from the sub equipment EQ1 to the main equipment EQ0, the counter of the main equipment EQ0 counts the counted value N from the time when the data is sent to the sub equipment EQ1 to the time when the data is returned and received from the sub equipment EQ1, and one-half the counted value N, that is, N/2, is corrected as the communication time. A counted value Pi of the counter of the main equipment EQ0 at the instant when the counters of the main and sub equipments EQ0 and EQ1 are set to a counted value Xi, can be obtained as. Pi=Xi+N/2.

Accordingly, when recording the synchronizing signal which forms the event information generated and recorded in the main and sub equipments EQ0 and EQ1 in the information file by the information file generating module 43, the synchronizing signal of the main equipment EQ0 is corrected by the operation formula Pi=Xi+N/2. Consequently, the error of the event information between the main and sub equipments EQ0 and EQ1 amounting to the time it takes for the communication between the main and sub equipments EQ0 and EQ1 is eliminated.

Next, a description will be given of the third technique for synchronizing the main information 55 and the meta information 53 and 57, by referring to FIG. 7. In FIG. 7, those parts which are the same as those corresponding parts in FIG. 5 are designated by the same reference numerals, and a description thereof will be omitted. According to the first and second techniques described above in conjunction with FIGS. 5 and 6, the counters of the main and sub equipments EQ0 and EQ1 are reset approximately at the same time and synchronized. On the other hand, this third technique the counters of the main and sub equipments EQ0 and EQ1 (or a plurality of equipments 1 through N) count freely.

In other words, the main equipment EQ0 sends an instruction which instructs the start of the recording to the sub equipment EQ1, and thereafter, the sub equipment EQ1 records the counted value of the counter at the instant when the event is detected and the corresponding contents of the detected event. Of course, the recording of the counted value of the counter at the instant when the event is detected and the corresponding contents of the detected event is also carried out in the main equipment EQ0. In this case, the counted values of the counters of the main and sub equipments EQ0 and EQ1 at a certain time or, the counted values of the counters of a plurality of equipments at the certain time if a plurality of equipments EQ1 are provided, do not need to be the same and may differ.

When the counted value at the instant when the event is detected and the corresponding contents of the detected event are recorded in each of the main and sub equipments EQ0 and EQ1 and the presentation ends, the main equipment EQ0 sends an instruction which instructs the end of the recording to the sub equipment EQ1. The sub equipment EQ1 sends a counted value Xe of the counter at this point in time, together with the recorded information in the sub equipment EQ1, to the main equipment EQ0. In this case, when the counter of the main equipment EQ0 from the start of the recording to the end of the recording reaches a counted value C, it may be estimated that a counted value Xs of the counter of the sub equipment EQ1 at the start of the recording is (Xe−C). Hence, if the counted value of the counter of the main equipment EQ0 at the start of the recording is denoted by Ps, a correction value D for the counters between the main and sub equipments EQ0 and EQ1 can be described by D=(Xs−Ps). As a result, if the counter of the sub equipment EQ1 has a counted value Xi at a certain time, the counted value Pi of the main equipment EQ0 at this certain time can be obtained from Pi=Xi−D.

Accordingly, when recording the synchronizing signal which forms the event information generated and recorded in the main and sub equipments EQ0 and EQ1 in the information file by the information file generating module 43, the synchronizing signal of the main equipment EQ0 is obtained by the operation formula Pi=Xi−D. Consequently, the error of the event information between the main and sub equipments EQ0 and EQ1 amounting to the time it takes for the communication between the main and sub equipments EQ0 and EQ1 is eliminated.

The event information which is automatically generated according to any of the first through third techniques described above in conjunction with FIGS. 5 through 7 may be edited manually. In other words, in this embodiment, the imaging PC 5 having the information file generating module 43 is provided with a function of editing the event information. Such an event information editing function requires a conversion module for converting the counted value of the counter and the representation thereof into a unit easily recognizable by hunch, and for converting the unit back into the original unit after the editing ends. This conversion module is provided in the imaging PC 5.

In this case, the unit easily recognizable by hunch may be units in seconds, units in frames or the like. The counted value of the counter may be represented in hour, minute, second and millisecond, in number of frames, or the like. It only becomes troublesome to manage the unit if the unit is too small, and thus, it is generally desirable for the unit to be rough to a certain extent so that the unit is easily recognizable by hunch. The unit may be made variable depending on the accuracy that is required.

Since the conversion module can convert the counted value of the counter and the representation thereof into a unit easily recognizable by hunch, and converts the unit back into the original unit after the editing ends, it is possible to conveniently and manually edit the event information which is generated automatically. The editing operation may carry out a text editing with respect to the text which is converted by the conversion module. In addition, the conversion module may be built into an event editing tool. In the case of an application (program) which has a predetermined purpose of using the event, the adding time of one unit of the counter may be determined to one second in advance, for example, so as to eliminate the trouble of conversion.

Therefore, the main information 55 formed by the audio-visual information group and the meta information 53 and 57 managing the content information thereof may be synchronized by the above described processes based on any of the first through third techniques described above in conjunction with FIGS. 5 through 7. The above described processes of the PCs 2 and 5 are carried out by analyzing and executing the information file generating program which is installed in the PCs 2 and 5.

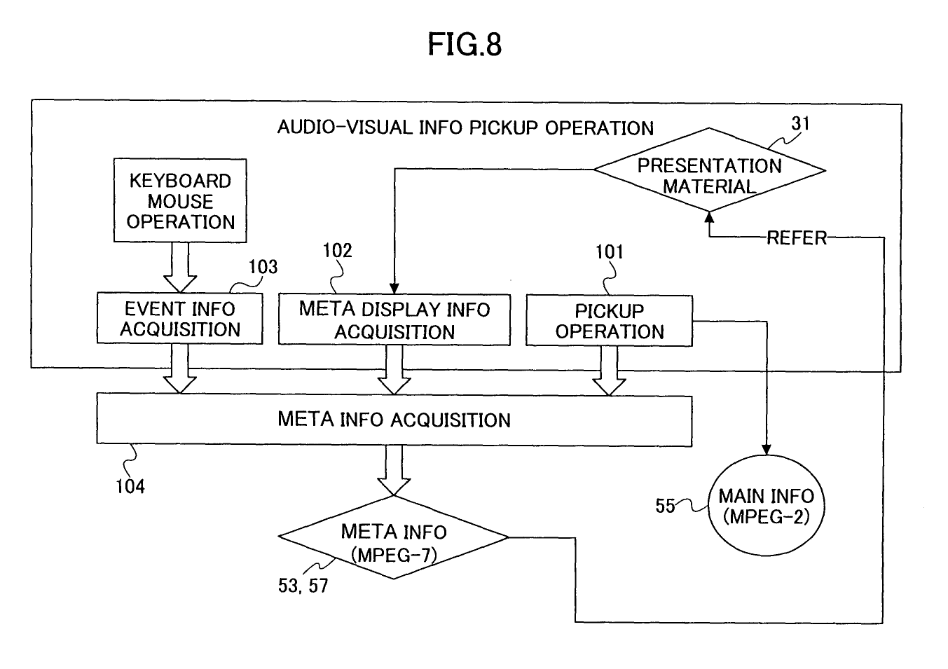

FIG. 8 is a diagram for explaining a capturing process with respect to the main information 55 and the meta information 53 and 57, and a file structure of an information file generated by the capturing process. As shown in FIG. 8, when carrying out an audio-visual information pickup operation, an actual pickup operation 101 is carried out by the DV camera 4, and in addition, a meta display information acquisition 102 which acquires the presentation material 31 as the meta display information and an event information acquisition 103 responsive to an operation of the keyboard 21 or the mouse 15 are carried out. Hence, the meta information 53 and 57 are generated by a meta information acquisition 104. The meta information 53 and 57 are converted into the MPEG-7 format, for example, and stored. On the other hand, the information which is obtained as a result of the actual pickup operation 101 carried out by the DV camera 4 is converted into the MPEG-2 format, for example, and stored as the main information 55. Consequently, an information file is generated from the main information 55 and the meta information 53 and 57.

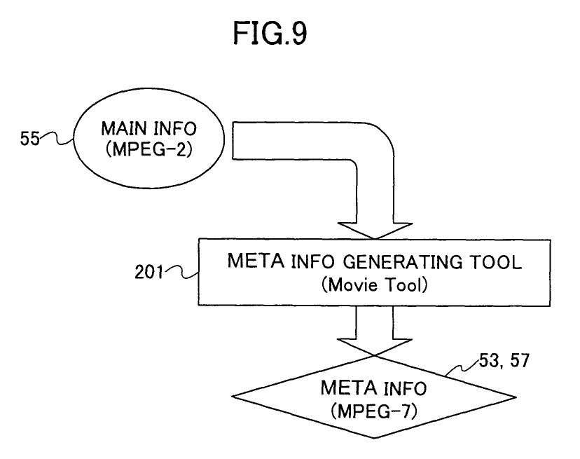

FIG. 8 shows the generation of the main information 55 and the meta information 53 and 57 by the capturing process described above with reference to FIGS. 1 through 4C. However, it is of course possible to generate the main information 55 and the meta information 53 and 57 differently, and for example, the meta information 53 and 57 may be generated manually. In other words, the meta information 53 and 57 may be generated manually by the user by writing the meta information 53 and 57 while watching the main information 55, that is, the video information, as shown in FIG. 9.

FIG. 9 is a diagram for explaining a manual information file generating process. In this case, the user forms structures of the audio-visual information of the main information 55 which is actually being monitored by use of a meta information generating tool 201, and adds the necessary meta information 54 and 57 (meta display information 51 and event information 52) to each structure, so as to generate the information file, as shown in FIG. 9.

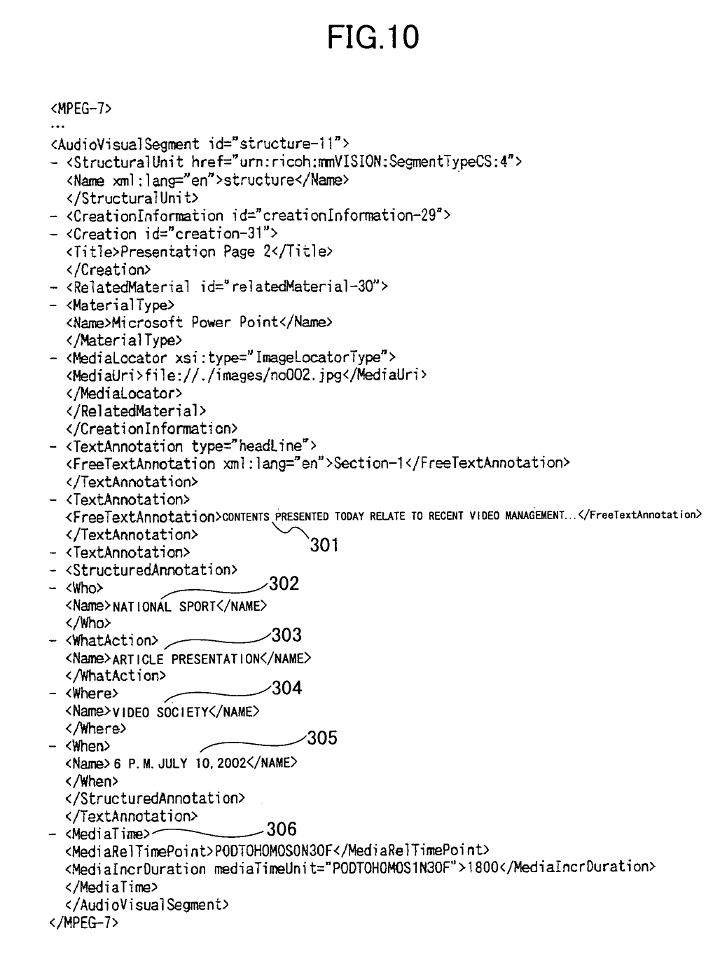

FIG. 10 is a diagram showing the meta information 53 and 57 written in MPEG-7. In this particular case shown in FIG. 10, caption information 301, appearing character 302, activity 303, place 304 and date and time 305 are written with respect to a scene within the video information. Such information 301 through 305 written in the meta information 53 and 57 become supplemental information (meta display information 51) with respect to the video information (main information 55) which is actually inspected by the user. Since the supplemental information (meta display information 51) exists independently of the main information 55, the supplemental information (meta display information 51) can freely take various display formats.

In the description given heretofore, the main information 55 is formed by the audio-visual information. However, the main information may be formed by any kind of time-varying audio and/or visual information which changes with time. For example, image information related to animation or the like may be treated as the main information 55 as long as the image information is time-varying and is not related to a still image.

In other words, the audio-visual information of the main information 55 may be the video information only, the image information only, the audio information only, a combination of the video and audio information or, a combination of image and audio information. Hence, the meta information 53 and 57 can be generated independently of the main information 55.

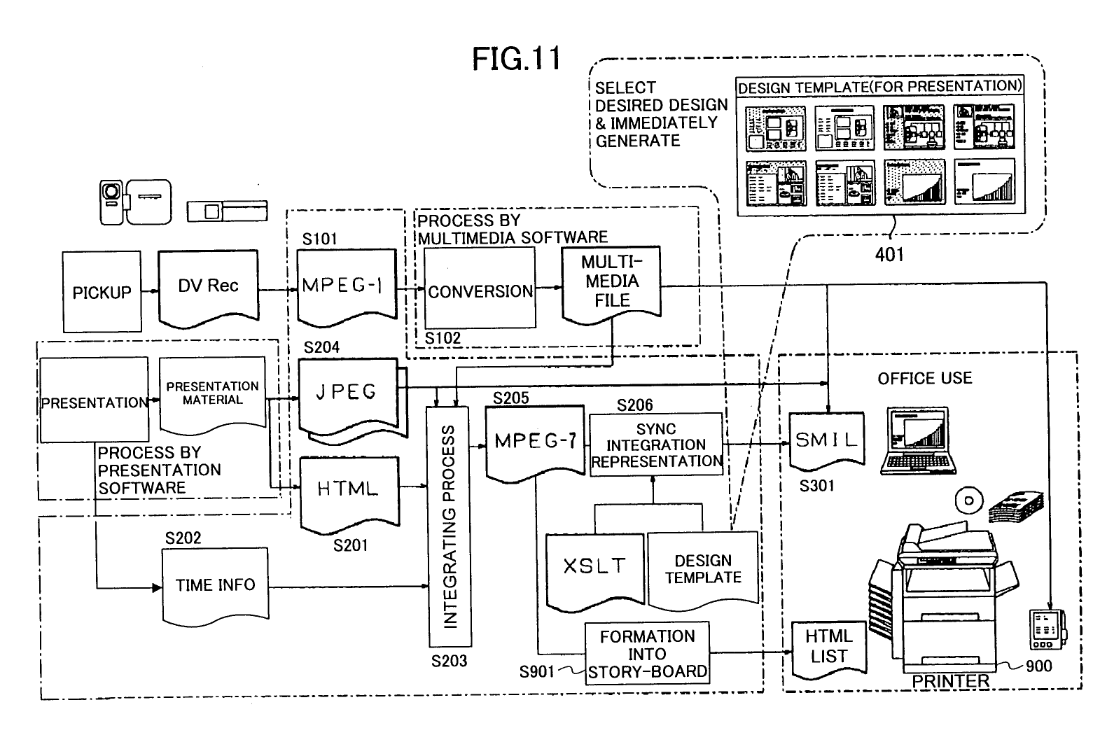

Next, a more detailed description will be given of the file structure of the information file, by referring to FIG. 11. FIG. 11 is a diagram showing the file structure of the information file in more detail.

In FIG. 11, the audio-visual information (audio-visual data) picked up by the DV camera 4 is recorded within a storage of the DV camera 4 as indicated by “DV Rec”, and is converted into digital data having the MPEG-1 format or the like in a step S101 by capturing and encoding the audio-visual information, and is further converted into a multimedia file by a multimedia software in a step S102, so as to become the main information 55. Of course, the audio-visual information picked up by the DV camera 4 may be input directly or, input after once storing the audio-visual information.

The presentation material 31 which is used for the presentation is converted into an HTML format according to the information file generating program described above in a step S201, so as to become the meta display information 51 which is displayable. At the same time, the event information 52 is captured in a step S202. The meta display information 51 and the event information 52 are integrated by an integrating process in a step S203, so as to generate the meta information 53 and 57. The presentation material 31 which is displayed as image during the presentation is compressed into image data according to JPEG in a step S204. Hence, the image data obtained by compressing the presentation material 31 is also integrated as other meta display information 51, when integrating the meta display information 51 and the event information by the integrating process in the step S203. The integrated data obtained by the integrating process is converted into a data format of the MPEG-7 in a step S205.

The data obtained in the step S205 may be formed into a story-board in a step S901 which displays a thumbnail image of each scene of the audio-visual information (main information) and the meta information in an easily understandable list or table. In this particular case shown in FIG. 11, an HTML list is displayed by the story-board and may be printed by a printer 900, for example. In other words, the story-board enables easy utilization of the multi-media information by an office equipment.

The main information 55 which is converted into the multimedia file in the step S102 may also be integrated with the meta display information 51 and the event information 52 in the step 203.

Alternatively, the main information 55 which is converted into the multimedia file in the step S102 may be integrated using the Synchronized Multimedia Integration Language (SMIL) in a step S301, with the meta information 53 and 57 which is converted into an XSLT structure having a synchronized integration representation in a step S206. Various templates 401 may be used when carrying out such an integrating process in the step S301.

The information file may be reproduced in the following manner. For example, the information file which is generated in the above described manner may be reproduced in a personal computer (PC). This PC may have an architecture shown in FIG. 2. In other words, the PC in this embodiment has a CPU 11 and a memory 12 which are connected via a bus 13. The CPU 11 carries out various operations and centrally controls each part of the PC. For example, the memory 13 includes a ROM which may store one or more computer programs to be executed by the CPU 11 and various data to be used by the CPU 11, and a RAM which may store various data including intermediate data obtained during operations carried out by the CPU 11.

A storage unit 14 having one or more magnetic hard disks, a mouse 15, a keyboard 21, and a display unit 16 are connected to the bus 13 via suitable interfaces. The mouse 15 and the keyboard 21 are provided as input devices, and the display unit 16 is provided as an output device. The display unit 16 is formed by a liquid crystal display (LCD) or the like. A medium reading unit 18 which reads a storage medium 17 such as an optical disk, may be connected to the bus 13. In addition, a communication interface (I/F) 20 which communicates with a network 19 such as the Internet, may be connected to the bus 13. The storage medium 17 may be selected from various types including flexible disks, magneto-optic disks, and optical disks such as compact disks (CDs) and digital versatile disks (DVDs). An optical disk unit, a magneto-optic disk unit or the like is used for the medium reading unit 18 depending on the type of the recording medium 17 used.

An information file reproducing program is stored in the storage unit 14 of the PC. This information file reproducing program may be read from the storage medium 17 by the medium reading unit 18 or, downloaded from the network 19 such as the Internet via the communication interface 20, and installed in the storage unit 14. The hard disk of the storage unit 14 or the storage medium 17 read by the medium reading unit 18 forms the computer-readable storage medium which stores the information file reproducing program.

By installing the information file reproducing program in the storage unit 14, the PC assumes a state capable of reproducing an information file. In other words, the CPU 11 can carry out operations based on the information file reproducing program, so as to realize functions (various means and steps of the present invention) of various modules which will be described later. The information file reproducing program may form a portion of a particular application software. The information file reproducing program may also operate on a predetermined operating system (OS) or, operate by use of a portion of the operating system.

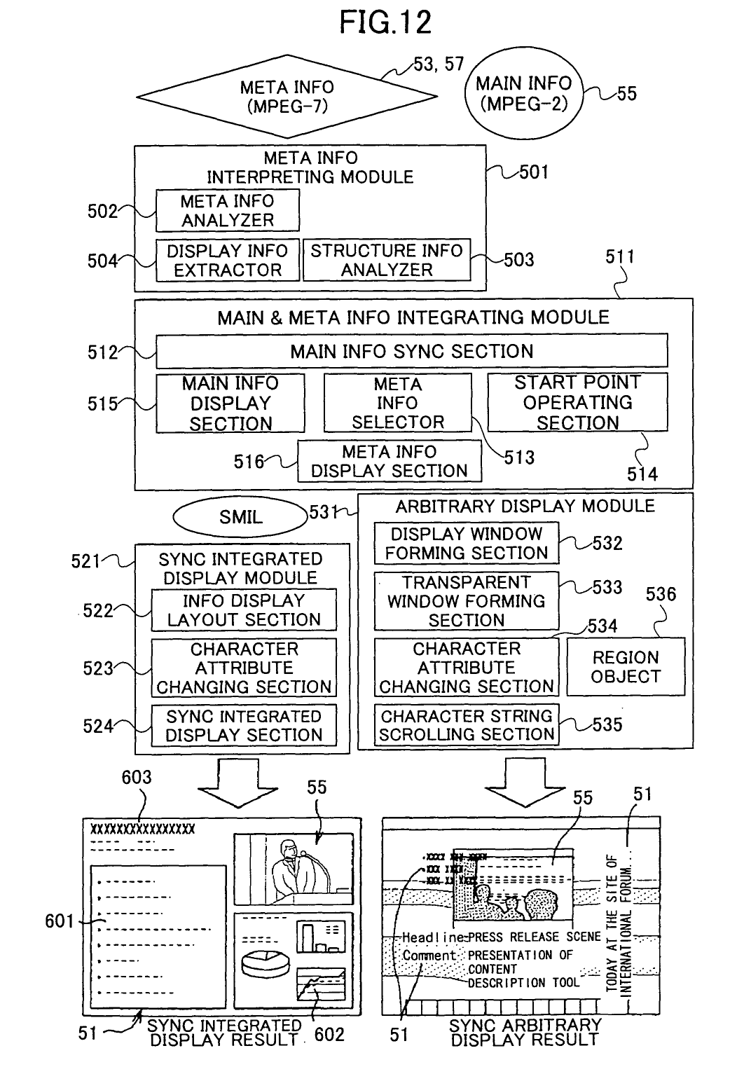

FIG. 12 is a functional block diagram for explaining an information file reproducing process carried out by the information file reproducing program. FIG. 12 shows the functions carried out by the PC based on the information file reproducing program, in blocks.

First, in FIG. 12, the contents of the main information 55 and the meta information 53 and 57 included in the information file are analyzed by a meta information analyzing module 501 which analyzes the document structure. Actually, a meta information analyzer 502 corresponding to an XML parser or the like analyzes the document structure. Thereafter, a structure information analyzer 503 analyzes the structure of the actual video information from a tag which represents the structure of the main information 55 within the document structure, so as to specify the contents of the meta information 53 and 57 and the appearing position of the video information. This tag corresponds to a portion 306 represented by <MediaTime> in FIG. 10. In addition, a display information extractor 504 extracts information which may actually be displayed according to a request or the like made by the user, from the main information 55 and the meta information 53 and 57.

Next, a description will be given of reproduced information of the main information 55. Since the main information 55 is formed by the video information, the video information is displayed according to a frame rate thereof, that is, a number of frames reproduced per second. In a main and meta information integrating module 511, a main information synchronizing section 512 synchronizes the video information provided time and the meta information provided time. Then, a meta information selector 513 judges an item which is actually requested by the user to be displayed. If necessary, a start point operating section 514 clarifies a relationship of the video information structure and a start position (time), as related information, in order to enable skipping from the structure information to the specifying of the main information display position by the user. Based on the above information, a display instruction for displaying the main information 55 and the meta information 53 and 57 is output to a main information display section 515 and a meta information display section 516.

Therefore, it is possible to display the meta display information 51 with a desired display format, and it is possible to display only the necessary meta information 53 and/or 57. Furthermore, an instantaneous access to the desired location of the main information 55 is possible.

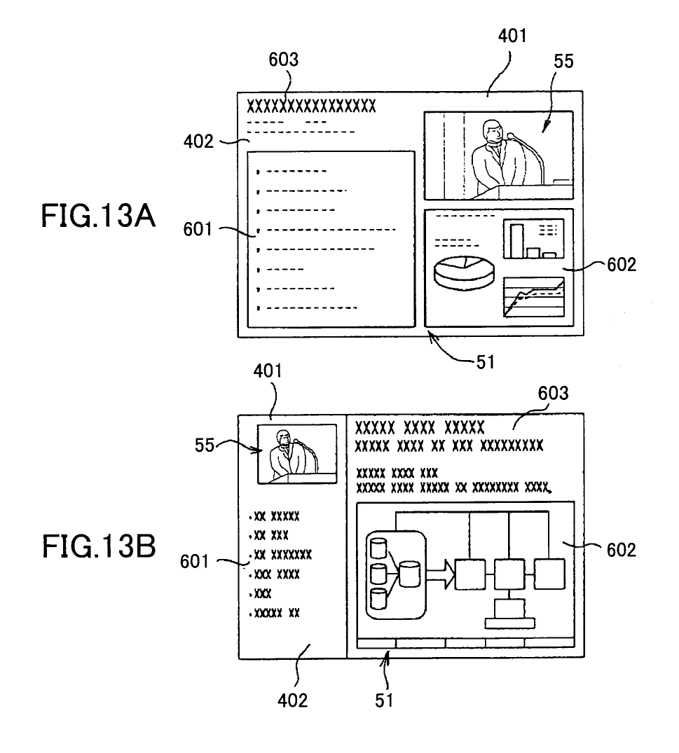

FIGS. 13A and 13B are diagrams for explaining integrated displays of information in an SMIL template 401 based on the meta information 53 and 57. By appropriately arranging the main information (video information) 55 and the meta display information 51 within one template (template information) 401, it is possible to make an integrated display of the main information (video information) 55, video structure information 601, related material 602 (page displayed by the presentation software), title 603 and the like. In this state, the template (or design template) 401 sets the arrangement (or layout) of the main information 55 and the meta display information 51 and the kind of background image 402. In addition, by preparing various display layout patterns for the template 401, it is possible to generate the display screen in a simple manner. The user simply needs to select an arbitrary template (display layout pattern) 401 depending on the video contents, atmosphere and the like.

The synchronized integrated (or merged) display described above is carried out by a synchronized integrated display module 521 shown in FIG. 12. The synchronized integrated display module 521 includes an information display layout section 522, a character attribute changing section 523, and a synchronized integrated display section 524. The synchronized integrated display section 524 carries out the synchronized integrated display, and the information display layout section 522 sets the information display layout depending on the selected template 401. The character attribute changing section 523 changes the attribute of the character in the meta display information 51, such as the color, font, size and the like of the character, depending on the selected template 401.

FIGS. 13A and 13B show the integrated displays which are made using mutually different templates 401.

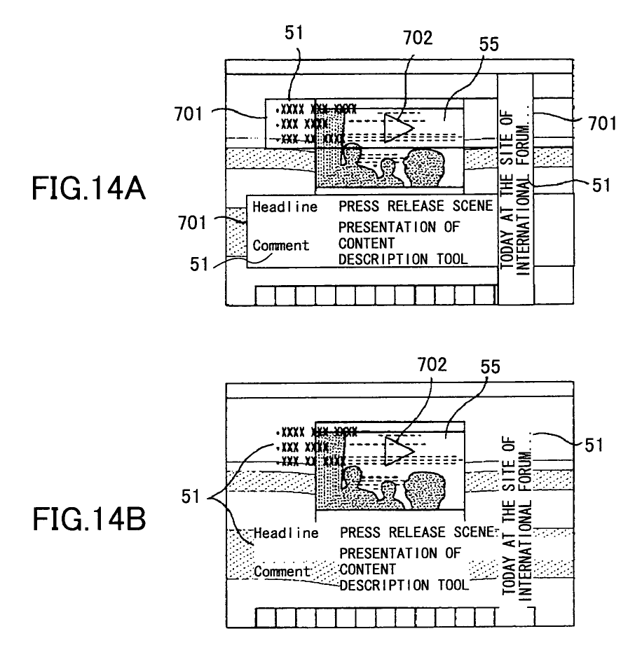

FIGS. 14A and 14B are diagrams for explaining arbitrary displays of the meta display information 51. FIG. 14A shows a case where the meta display information 51 is displayed within a window 701, and this window 701 is movable to an arbitrary position. FIG. 14B shows a case where the meta display information 51 is displayed within a window 701 but a background and a frame of the window 701 are transparent. In other words, in FIG. 14B, only the characters and objects displayed within the window 701 are visible, so as to minimize interference to the inspection of other information.

Actually, with respect to a character string longer than a width of the window 701, an automatic scroll function is provided to automatically scroll the character string, so that the character string scrolls within the window 701 as in the case of an electric bulletin board. The scrolling of the character string may be made at arbitrary speed or at a speed synchronized to the scene time of the video information of the main information 55, for example. A completion time of the scrolling (scroll completion time) is controlled to be synchronized with the main information 55. Hence it is possible to display the entire meta display information 51 even when the meta display information 51 is long. It is also possible to draw the user's attention on the meta display information 51.

By arbitrarily changing the attribute of the character to be displayed, such as the color, font size and the like of the character string, it is possible to distinguish the meaning and/or importance of the displayed information.

In addition, an object 702 for acquiring an event is displayed within the display which arbitrarily displays the meta display information 51. This object 702 is arranged in an overlapping manner on the video display screen (main information 55) as a video reproduction or stop instruction button, for example. In this case, the video reproduction or stop operation may be made by clicking the video reproduction or stop button by the mouse 15. In other words, in addition to the display information of the object 702, the meta display information 51 includes the event which depends on the contents of the main information 55 to which the object 702 is related (or positioned). Hence, it is possible to execute the event included in the meta display information 51 by clicking and selecting the object 702 by the mouse 15. It is also possible to display the object 702 in a transparent manner. In this case, the object 702 will not interfere with the display of the main information 55.

Of course, the meta display information 51 may be displayed at a non-overlapping position with respect to the main information 55, so as not to interfere with the display of the main information 55.

The synchronized integrated display described above is carried out by an arbitrary display module 531 shown in FIG. 12 which is capable of freely making a display at an arbitrary position. The arbitrary display module 531 includes a display window forming section 532 for displaying the meta information, a transparent window forming section 533 for making the window transparent, a character attribute changing section 534, a character string scrolling section 535, and a region object 536. The window forming section 532 displays the meta display information 51 within the window 701. The transparent window forming section 533 makes the window 701 completely transparent. The character attribute changing section 534 arbitrarily changes the attribute of the character to be displayed. The character string scrolling section 535 realizes the automatic scroll function which automatically scrolls the character string. The region object 536 carries out a display process to display the object 702 and carries out the event when this object 702 is selected.

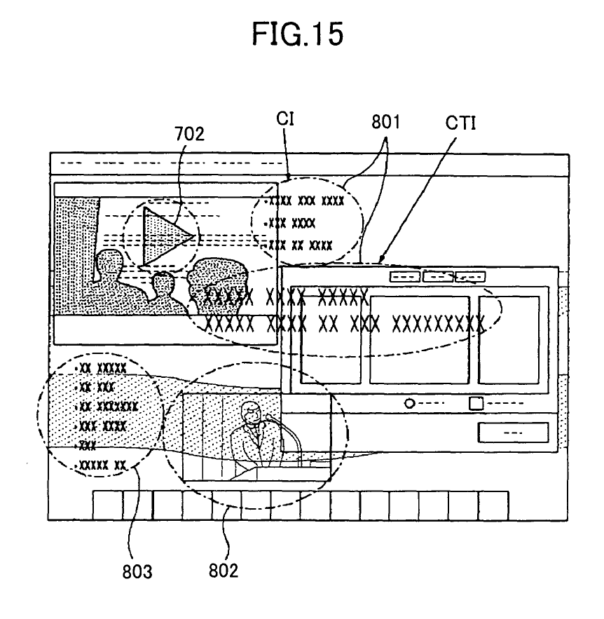

FIG. 15 is a diagram for explaining a display of the information file. As shown in FIG. 15, the meta display information 51 may include supplemental information 801 for helping understanding of the main information 55, related information 802 which is related to the main information 55, and structure information 803 which represents the structure of the main information 55. The structure information 803 clarifies the structure of the main information 55 and helps the systematic understanding of the main information 55.

In FIG. 15, the supplemental information 801 is realized by content information CTI and caption information CI. The content information CTI is displayed based on information such as the appearing character 302, the activity 303, the place 304, the date and time 305 and the like with respect to a certain scene within the video information shown in FIG. 10. For example, the content information CTI displays the scene content information, such as the appearing character, place, date and time and the like of a certain scene of the main information 55 which is presently being reproduced. Hence, the content information CTI enables a more detailed understanding of this certain scene of the main information 55. The caption information CI is displayed based on the caption information 301 with respect to the certain scene within the video information shown in FIG. 10. For example, the caption information CI is displayed by scrolling the corresponding caption with respect to the main information 55 which is presently being reproduced. Therefore, the supplemental information 801 is effective in helping the user's understanding of the main information 55.

For example, the related information 802 is related to the certain scene of the main information 55 which is presently being reproduced. In the case shown in FIG. 15, the related information 802 displays a representative frame (key frame) within the scene. Of course, the related information 802 is not limited to the representative frame, and for example, related images, presentation document images and the like may be used as the related information 802 and included in the meta display information 51.

For example, the structure information 803 is obtained by extracting the structure information of the main information 55 from the meta display information 51, and is displayed in the form of character strings respectively corresponding to the headings of each of the structures. Accordingly, the user can easily recognize and understand the total structure of the main information 55. Alternatively, in the structure information 803, a character string corresponding to a scene of the main information 55 which is presently being reproduced may be highlighted (or displayed in a color different from the rest), so as to facilitate the understanding of the scene (portion) that is being reproduced.

The object 702 is displayed in the case of the displayed information file shown in FIG. 15. This object 702 is the same as the object 702 described above in conjunction with FIGS. 14A and 14B. In other words, the object 702 may be structured so that various events are generated by the selection of this object 702. For example, if the object 702 which is displayed in an overlapping manner on a scene of the main information 55 is selected, it is possible to display information related to the appearing character or object appearing in this scene. In this case, the meta display information 51 may hold the information related to the appearing character or object in the format shown in FIG. 12, but it is also possible to set a hyper link with respect to the meta display information 51. In other words, the information itself related to the appearing character or object may be stored at a location accessible by URL, for example, and a hyper link which specifies this URL may be written in the meta display information 51. The event generated by the object 702 is of course not limited to a certain kind, and any kind of event may be generated thereby. In this case, it is extremely easy to set the object 702, because the object 702 is not embedded within the main information 55.

Further, the present invention is not limited to these embodiments, but various variations and modifications may be made without departing from the scope of the present invention.

What is claimed is:

1. An information file data structure comprising:
time-varying audio-visual main information; and
meta information, annexed to the main information, including meta display information which is displayable and event information for synchronizing display of the meta display information to the main information.

2. The information file data structure as claimed in claim 1, wherein the main information includes video information.

3. The information file data structure as claimed in claim 1, wherein the main information includes image information.

4. The information file data structure as claimed in claim 1, wherein the main information includes audio information.

5. The information file data structure as claimed in claim 1, wherein the meta display information includes supplemental information for helping understanding of the main information.

6. The information file data structure as claimed in claim 1, wherein the meta display information includes related information related to the main information.

7. The information file data structure as claimed in claim 1, wherein the meta display information includes structure information representing a structure of the main information.

8. The information file data structure as claimed in claim 1, wherein the event information of the meta information includes a counted value of a counter.

9. An information file generating method comprising the steps of:
(a) generating time-varying audio-visual main information; and
(b) generating meta information, annexed to the main information, including meta display information which is displayable and event information for synchronizing display of the meta display information to the main information.

10. The information file generating method as claimed in claim 9, wherein said step (b) comprises:
carrying out a counting operation by a counter when reproducing the main information; and
inputting as the event information a counted value of the counter when an event is generated with respect to the meta information.

11. An information file generating apparatus comprising:
a first generating section to generate time-varying audio-visual main information; and
a second generating section to generate meta information, annexed to the main information, including meta display information which is displayable and event information for synchronizing display of the meta display information to the main information.

12. The information file generating apparatus as claimed in claim 11, wherein said second generating section comprises:
means for carrying out a counting operation by a counter when reproducing the main information; and
means for inputting as the event information a counted value of the counter when an event is generated with respect to the meta information.

13. A computer-readable storage medium which stores a computer program for causing a computer to generate an information file, said computer program comprising:
a first procedure to cause the computer to generate time-varying audio-visual main information; and
a second procedure to cause the computer to generate meta information, annexed to the main information, including meta display information which is displayable and event information for synchronizing display of the meta display information to the main information.

14. The computer-readable storage medium as claimed in claim 13, wherein said second procedure comprises:
causing the computer to carry out a counting operation by a counter when reproducing the main information; and
causing the computer to input as the event information a counted value of the counter when an event is generated with respect to the meta information.

15. An information file reproducing method comprising the steps of:
(a) analyzing an information file comprising time-varying audio-visual main information and meta information, said meta information being annexed to the main information and including meta display information which is displayable and event information for synchronizing display of the meta display information to the main information; and
(b) reproducing the main information and the meta display information of the information file which is analyzed by synchronizing the main information and the meta display information by the event information.

16. The information file reproducing method as claimed in claim 15, wherein said step (b) includes a conversion process to convert the main information and the meta information into a Synchronized Multimedia Integrated Language (SMIL).

17. The information file reproducing method as claimed in claim 16, wherein the conversion process sets an arrangement of the main information and the meta display information and a kind of background image based on template information.

18. The information file reproducing method as claimed in claim 15, wherein said step (b) includes selecting a display format of the meta display information.

19. The information file reproducing method as claimed in claim 15, wherein said step (b) includes selectively displaying the meta display information.

20. The information file reproducing method as claimed in claim 15, wherein said step (b) moves a reproducing time of the main information to a time corresponding to a selected structure information if the meta display information includes the structure information which represents a structure of the main information.

21. The information file reproducing method as claimed in claim 15, wherein said step (b) includes displaying the meta display information at a non-overlapping position with respect to a display of the main information if the main information is displayable.

22. The information file reproducing method as claimed in claim 15, wherein said step (b) includes displaying the meta display information in a transparent window if the main information is displayable.

23. The information file reproducing method as claimed in claim 15, wherein said step (b) includes scrolling and displaying the meta display information.

24. The information file reproducing method as claimed in claim 23, wherein said step (b) synchronizes a scroll completion time of the meta display information to the main information.

25. The information file reproducing method as claimed in claim 15, wherein said step (b) includes selecting an attribute of a character included in the meta display information.

26. The information file reproducing method as claimed in claim 15, wherein said step (b) comprises:
displaying a selectable object for acquiring an event and the main information in an overlapping manner; and
generating an event set in the meta display information when the object is selected.

27. The information file reproducing method as claimed in claim 26, wherein said step (b) includes displaying the object in a transparent manner.

28. The information file reproducing method as claimed in claim 15, wherein the event information included in the meta information includes a counted value of a counter.

29. An information file reproducing apparatus comprising:
an analyzing section to analyze an information file comprising time-varying audio-visual main information and meta information, said meta information being annexed to the main information and including meta display information which is displayable and event information for synchronizing display of the meta display information to the main information; and
a reproducing section to reproduce the main information and the meta display information of the information file which is analyzed by synchronizing the main information and the meta display information by the event information.

30. The information file reproducing apparatus as claimed in claim 29, wherein the event information included in the meta information includes a counted value of a counter.

31. A computer-readable storage medium which stores a computer program for causing a computer to reproduce an information file, said computer program comprising:
a first procedure causing the computer to analyze an information file comprising time-varying audio-visual main information and meta information, said meta information being annexed to the main information and including meta display information which is displayable and event information for synchronizing display of the meta display information to the main information; and
a second procedure causing the computer to reproduce the main information and the meta display information of the information file which is analyzed by synchronizing the main information and the meta display information by the event information.

32. The computer-readable storage medium as claimed in claim 31, wherein the event information included in the meta information includes a counted value of a counter.
